(19) United States
(12) Patent Application Publication
(10) Pub. No.: US 2009/0312228 A1
(43) Pub. Date: Dec. 17, 2009

(54) AQUEOUS CLEANING CONCENTRATES

(76) Inventors: Katie Bocage, Sicklerville, NJ (US); Kristin Buentello, Newtown, PA (US); Megan Kouba, Toms River, NJ (US); Mark Ventura, Freehold, NJ (US)

Correspondence Address: Stephen B. Shear;Church & Dwight Co., Inc. - Law Dept., 469 North Harrison Street, Princeton, NJ, 08543-5297, US

(21) Appl. No.: 12/137,306

(22) Filed: Jun. 11, 2008

(51) Int. Cl. C11D 3/60

(52) U.S. Cl. 510/420; 510/405; 510/434

(57) ABSTRACT

A highly concentrated aqueous cleaning solution which is stable in concentrated and diluted form and is effective upon dilution with water having a water hardness level of 0-350 ppm comprises 10-30 wt. % water, a chelating agent, an aminoalkanol solvent, at least one surfactant, and optionally, an organic alcohol or glycol ether solvent.

### FIELD OF THE INVENTION

The present invention is directed to novel aqueous cleaning concentrates which are in the form of a stable, uniform single phase and having a reduced water content. The aqueous cleaning concentrates are diluted with a known amount of tap water in a container by the consumer and the diluted aqueous concentrate remains stable and effective in aqueous solution over a wide range of water hardness levels. The diluted concentrates can be stored in the container and periodically used as needed from the container, such as, by means of a spray nozzle.

### BACKGROUND OF THE INVENTION

Cleaning concentrates in aqueous solution are typically marketed to the consumer in glass bottles or plastic containers in which the consumer pours a small amount of the concentrate into a larger container, such as a plastic bucket, containing water for use. The diluted cleaning formulation is used to clean hard surfaces such as floors, walls, countertops, windows, glass, etc., such as by means of a cleaning substrate, e.g. mop, sponge, cloth, etc. Any diluted cleaning formulation which remains after the cleaning process is completed is simply thrown away since over a short period of time, the diluted concentrate will no longer be stable resulting in the separating out of valuable cleaning components from the composition. Obviously, the leftover diluted cleaning formulation which must be thrown away represents an economic waste and loss for the consumer. Another difficulty with the common “bucket diluteable” aqueous concentrates is that the concentrates are not always stable and effective in a variety of water hardness levels. Thus, as the level of water hardness ions increases from 0 to 350 ppm or more in the tap water used for dilution, the stability and effectiveness of the diluted aqueous concentrate can also vary.

Ready to use aqueous formulations are typically provided to the consumer in plastic or glass bottles that often contain a spray nozzle so as to apply the aqueous cleaning solution to the surface desired to be cleaned. Such compositions typically contain large amounts of water or other solvents. Accordingly, shipping the ready to use cleaner is costly due to the weight of the water and, overall, not very energy efficient when cost of transportation to market the product is considered. Further, once the cleaning formulation is consumed, the container then becomes waste. Inasmuch as the recycling of plastics is in its infancy, the empty container simply becomes part of the non-degradable landfill.

Conventional cleaning preparations for hard surfaces are generally aqueous preparations which are present either as solutions or as suspensions and which are commercially available in liquid or paste-like form. The principal constituents of preparations such as these are surfactants, complexing agents for the hardness constituents of water, abrasives, and organic solvents, the quantity in which the individual constituents are present being variable within wide limits according to the particular application. Cleaning preparations especially intended for the cleaning of glass and ceramic surfaces are frequently formulated as solutions of the active components in a mixture of water and water-soluble organic solvents, primarily lower alcohols and glycol ethers.

Apart from the obvious need for high cleaning power, cleaning preparations of the above type are also required to lend themselves to simple and convenient application. At the same time, the preparations are often required to develop an almost automatic effect, i.e. they are expected to provide the desired effect after only a single application without any further treatments. This is difficult to achieve, particularly where the preparations are applied to smooth surfaces, more especially to smooth surfaces which, like glass or ceramics, are capable of mirror-like reflection. In general, it is necessary with conventional preparations to rinse off residues of the preparations after the actual cleaning process or to carefully polish and dry the surfaces after application to avoid visible residues on the smooth surfaces.

At present, it is advantageous for products to be environmentally friendly wherein the product itself, the manufacturing of the product, the distribution of the product, and the marketing of the product has a reduced carbon footprint, or in other words, produces less greenhouse gases during production, distribution, retailing, and use. Thus, for hard surface cleaners, the product itself should have a reduced organic compound content meaning typically, a reduced level of hydrocarbon solvents and, in particular, a reduced amount of organic surfactants. Moreover, the organic surfactants should themselves be preferably formed from renewable resources such as being from plant-based origins. At the same time, the cleaning product to be effective requires reactants to not only maintain the stability of the aqueous solutions, but to increase the cleaning power of the product. Furthermore, the product should be formulated and marketed to reduce the weight of the product during distribution so as to reduce the carbon footprint during transportation of the product from the production to the retailing outlet. Thus, a cleaning formulation which contains a large amount of water adds the most weight to the product and ultimately increases the carbon footprint of the product during the stage of product distribution to market. However, removing the water from the formulations is not an easy task as the formulation must be stable at high levels of active components in smaller amounts of water, and at the same time, the product must be convenient to use by the consumer, and not involve a significant amount of manipulation by the consumer to use as an aqueous diluted solution.

### SUMMARY OF THE INVENTION

The present invention is directed to an aqueous cleaning concentrate containing a minimum amount of water and in a form which allows convenient use by the consumer. The aqueous cleaning concentrate, whether in concentrated or diluted form, maintains a uniform composition for long periods of time and is effective when diluted with ordinary tap water having a widely varying water hardness content.

### BRIEF DESCRIPTION OF THE DRAWING

The FIGURE is a plan view of an example of a packaged aqueous concentrate of this invention together with a typical container containing a spray trigger, which can be used to dilute the aqueous concentrate and apply the diluted solution to a surface to be cleaned.

### DETAILED DESCRIPTION OF THE INVENTION

A typical aqueous cleaning concentrate marketed to the consumer contains large amounts of water, i.e. greater than 40 wt. % and is provided in containers which allow a portion of the concentrate to be poured into a larger portion of water, such as contained in a bucket or the like. As discussed above, the large amount of water in these “bucket dilutable” concentrates is disadvantageous due to the weight of the water and the consequent costs, both monetary and enviromentally, which are involved in transporting the commercial concentrates to market. Further, the diluted leftover solutions need to be thrown away since the diluted solution is not stable for very long. On the other hand, packaged “ready to use” aqueous cleaning solutions, such as those provided in spray bottles, also contain large amounts of water, i.e. greater than 80 wt. %, which also results in large transportation costs for distribution of the product.

The cleaning concentrates of the present invention have vastly minimal amounts of water compared to present “bucket dilutable” and “ready to use” cleaning formulations. In general, the level of is water up to 30% by weight and preferably from greater than about 10% to less than 30% by weight of the concentrate. These highly concentrated aqueous formulations contain a combination of actives capable of providing the desired cleaning of hard surfaces, in particular, after being diluted with ordinary tap water of varying hardness content and are stable in both concentrated and diluted form. A description of the actives is presented below.

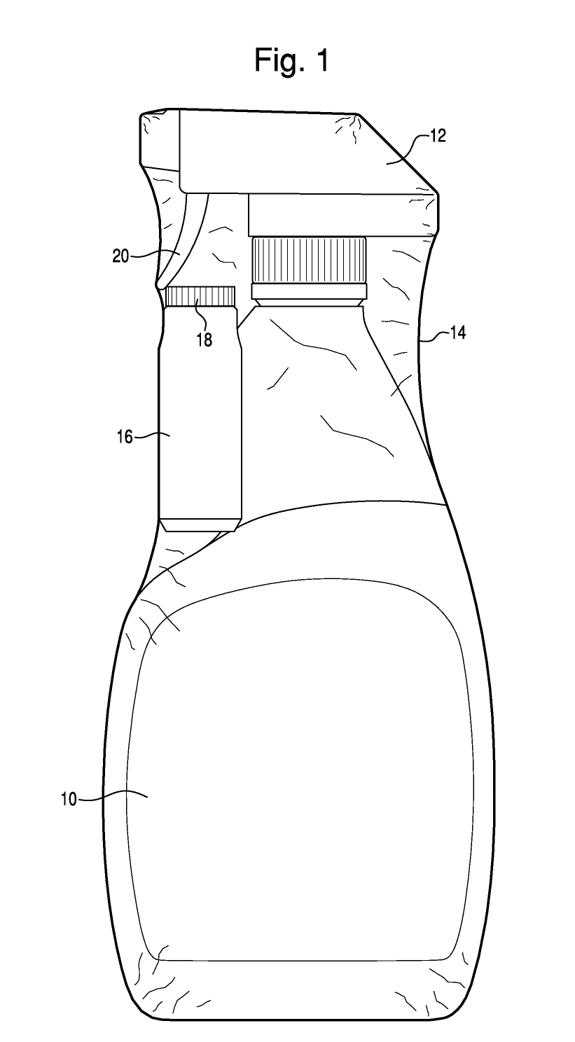

The aqueous concentrate of this invention is packaged to provide ideal convenience to the consumer. Thus, the aqueous concentrate will typically be provided in a container with a volume of at least 15 to 200 ml, such as a plastic or glass container which includes a top that can be readily opened. A flip top, screw-type opener, or any type of openable closure can be conveniently used to seal the concentrate and allow the dispensing of the concentrate from the container. Shown in FIG. 1 is an example of how the aqueous concentrate can be packaged. As shown in FIG. 1, a container 10 with a screw on trigger sprayer head 12 is wrapped in a plastic film 14, which also covers container 16, which holds the concentrate of the invention. Upon removal of the film 14, the consumer would remove the spray head 12, open the concentrate package 16, such as by removal of threaded top 18, and pour the contents of the concentrate into container 10. The consumer would then fill container 10 with tap water and replace the spray head 12. The concentrate of this invention is then properly diluted and ready to clean the desired surface by activating the spray head 12 such as by the trigger 20. It is preferred to dilute the concentrate so that the concentrate comprises 2-6% by weight of the total of added water and concentrate. Most preferably, the concentrate will be in the form of a 35 ml container which can then be diluted with 1 quart of water, forming approximately a 3.5 wt. % solution of the concentrate within the added water. The concentrate container can also be provided to the consumer as a refill package, which can be purchased separate from the container used to mix and apply the concentrate with added water.

The actives in the concentrate of the present invention are provided in particular to maintain the stability of the composition, whether in the concentrated or in the diluted form and, in particular, to be stable and effective when the concentrate is diluted with tap water, which can have a water hardness of from 0-350 ppm of cations. In particular, the composition of this invention includes a combination of a chelating agent and an aminoalkanol compound.

The composition according to the invention includes complexing or chelating agents that aid in reducing the harmful effects of hardness components in ordinary household (tap) water. Typically, calcium, magnesium, iron, manganese, or other polyvalent metal cations, present in tap water, can interfere with the action of either washing compositions or rinsing compositions. A chelating agent is provided for complexing with the metal cations and preventing the complexed metal cations from interfering with the action of active cleaning components of the composition. Both organic and inorganic chelating agents are common. Inorganic chelating agents include such compounds as sodium pyrophosphate, and sodium tripolyphosphate. Organic chelating agents include both polymeric and small molecule chelating agents. Polymeric chelating agents commonly comprise ionomer compositions such as polyacrylic acids compounds. Small molecule organic chelating agents include salts of ethylenediaminetetracetic acid (EDTA) and hydroxyethylenediaminetetracetic acid, nitrilotriacetic acid, ethylenediaminetetrapropionates, triethylenetetraminehexacetates, and the respective alkali metal ammonium and substituted ammonium salts thereof. Phosphonates are also suitable for use as chelating agents in the composition of the invention and include ethylenediamine tetra(methylenephosphonate), nitrilotrismethylenephosphonate, diethylenetriaminepenta(methylene phosphonate), hydroxyethylidene diphosphonate, and 2-phosphonobutane-1,2,4-tricarboxylic acid. EDTA is particularly preferred.

The aqueous liquid hard surface concentrate compositions also contain an alkaline material, preferably comprising monoethanolamine or beta-aminoalkanol compounds.

Monoethanolamine and/or beta-aminoalkanol compounds serve primarily as solvents. They also provide alkaline buffering capacity during use. However, the most unique contribution they make is to improve the removal of or reduce the delitorious affects of water hardness cations on the diluted hard surface cleaning compositions.

Preferred beta-aminoalkanols have a primary hydroxy group. Suitable beta-aminoalkanols have the formula:

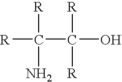

wherein each R is selected from the group consisting of hydrogen and alkyl groups containing from one to four carbon atoms and the total of carbon atoms in the compound is from three to six, preferably four. The amine group is preferably not attached to a primary carbon atom. More preferably the amine group is attached to a tertiary carbon atom to minimize the reactivity of the amine group. Specific preferred beta-aminoalkanols are 2-amino, 1-butanol; 2-amino, 2-methylpropanol; and mixtures thereof. The most preferred beta-aminoalkanol is 2-amino, 2-methylpropanol since it has the lowest molecular weight of any beta-aminoalkanol which has the amine group attached to a tertiary carbon atom. The beta-aminoalkanols preferably have boiling points below about 175° C. Preferably, the boiling point is within about 5° C. of 165° C.

Such beta-aminoalkanols are excellent materials for hard surface cleaning in general and, in the present application, have certain desirable characteristics.

Good filming/streaking, i.e., minimal, or no, filming/streaking, is especially important for cleaning of, e.g., window glass or mirrors where vision is affected and for dishes and ceramic surfaces where spots are aesthetically undesirable. Beta-aminoalkanols provide superior cleaning of hard-to-remove greasy soils and superior product stability. Beta-aminoalkanols, and especially the preferred 2-amino-2-methylpropanol, are surprisingly volatile from cleaned surfaces considering their relatively high molecular weights.

The concentrate compositions can contain in addition to the preferred alkanolamines, more conventional alkaline buffers such as ammonia; other C₂₋₄ alkanolamines; alkali metal hydroxides; silicates; borates; carbonates; and/or bicarbonates. Thus, the buffers that are present usually comprise the preferred monoethanolamine and/or beta-aminoalkanol and additional conventional alkaline material. The total amount of alkalinity source is typically from 0% to about 10% to give a pH in the product, at least initially, in use of from about 9 to less than about 12, preferably from about 9.5 to about 11.5.

The chelating agent will be present in the concentrate in amounts ranging from 0.5-10%, preferably from about 1-5 wt. %. The amino-containing solvent will be present in amounts of from about 2-20 wt. % with amounts of from 5-15% based on the weight of the concentrate preferable.

To enhance the cleaning ability of the formulation, the concentrate of this invention will contain at least one surfactant. The surfactant is selected from anionic, nonionic, and amphoteric surfactants and mixtures thereof.

The anionic surfactant is selected from alkyl sulfates, alkylbenzene sulfonates, alpha-olefin sulfonates, alkyl taurates, alkyl sarcosinates and the like. Each of these surfactants is generally available as the alkali metal, alkaline earth and ammonium salts thereof. The preferred anionic surfactant is alkyl sulfate, more preferably, C₆₋₁₆ alkyl sulfates. One particularly preferred sulfate is sodium lauryl (C₁₂) sulfate, available from Stepan Chemical Co., under the brand name Stepanol WAC. Because it appears desirable to limit the total amount of sodium ion present in the invention, it may also be preferred to use the alkaline earth salts of alkyl sulfates, particularly magnesium, and, less preferably, calcium, to bolster non-streaking/non-filming performance. Magnesium salts of the anionic surfactants are commercially available, however, a viable alternative is to form the magnesium salts in situ by the addition of soluble Mg⁺⁺ salts, such as MgCl₂, and the like. Calcium salts suitable for use would be CaCl₂, and the like. The level of these salts may be as high as 200 ppm, although less than 100 ppm is preferred, especially less than 50 ppm.

The nonionic surfactants are selected from alkoxylated alcohols, alkoxylated ether phenols, and other surfactants often referred to as semi-polar nonionics, such as the trialkyl amine oxides. The alkoxylated alcohols include ethoxylated, and ethoxylated and propoxylated C₆₋₁₆ alcohols, with about 2-10 moles of ethylene oxide, or 1-10 and 1-10 moles of ethylene and propylene oxide per mole of alcohol, respectively.

A preferred nonionic surfactant is a mixture marketed by Cognis Corpooration under the tradename Dehypound Advance. This surfactant blend is described in U.S. 2008/0039357, published Feb. 14, 2008. In accordance with the mentioned publication, the surfactant composition includes (a) an alkyl polyglycoside; (b) an ethoxylated alcohol with an average of about 1 to 30 moles of ethylene oxide per mole of alcohol; and (c) an alkoxylated alcohol with an average of about 1 to about 30 moles of ethylene oxide and about 2 to about 60 moles of propylene oxide per mole of alcohol, wherein the ratio of moles of ethylene oxide to moles of propylene oxide is about 1:2.

The alkyl polyglycoside may have an alkyl chain length of about 8 to about 16 carbon atoms, or about 8 to about 10 carbon atoms.

The ethoxylated alcohol may have an alkyl chain length of about 8 to about 16 carbon atoms, or about 8 to about 10 carbon atoms. The ethoxylated alcohol may have about 1 to about 10 moles of ethylene oxide, about 2 to about 6 moles of ethylene oxide, or about 4 moles of ethylene oxide. The ethoxylated alcohol may be an ethoxylated fatty alcohol.

The alkoxylated alcohol may have an alkyl chain length of about 12 to about 16 carbon atoms, or about 12 to about 14 carbon atoms. The alkoxylated alcohol may have about 1 to about 10 moles of ethylene oxide and about 2 to about 10 moles of propylene oxide, about 1 to about 8 moles of ethylene oxide and about 2 to about 10 moles of propylene oxide, about 2 to about 4 moles of ethylene oxide and about 4 to about 8 moles of propylene oxide, or about 3 moles of ethylene oxide and about 6 moles of propylene oxide. The alkoxylated alcohol may be an alkoxylated fatty alcohol. The alkoxylated fatty alcohol may be a block ethylene oxide/propylene oxide adduct.

Amphoteric surfactants such as betaines and amine oxides can also be used alone or in a mixture with other surfactants. Betaine amphoteric surfactants of particular value in the practice of the present invention are compounds represented by the following formula:

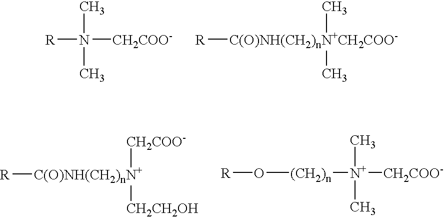

wherein R is C₄ to C₂₂ alkyl, alkylamidoalkyl or alkoxyalkyl and n is an integer of from about 2-20. The alkyl group or portion of the group is preferably about C₄ to about C₁₀.

A specific group of amide oxides that have also been found to be effective in the invention can be depicted by the following formulae:

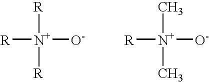

wherein R independently represents alkyl, aryl, or alkylaryl groups of from about 4 to about 18 carbon atoms or alkoxymethylene wherein the alkoxy group contains from about 4 to about 8 carbon atoms. Suitable amine oxide amphoteric surfactants useful in the process of the present invention include dihydroxyethyl cocomine oxide, dihydroxy tallowamine oxide, dimethyl cocoalkylamine oxide, dimethyl hexadecylamine oxide, cocomine oxide, lauryl oxypropyl dimethyl amine oxide, palmitamine oxide, hydrogenated tallowamine oxide and mixtures thereof.

Specific amine oxide compounds of this class which can be used in the invention include the following which are of the formulae:

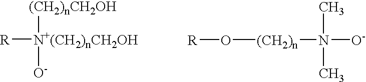

wherein R has been hereinbefore defined and n represents a whole integer of from about 1 to 22.

The total amount of surfactant included can vary from between about 1 to 60 wt. % of the concentrate.

Good cleaning can normally be further improved by the use of the right organic cleaning solvent. By organic cleaning solvent, it is meant an agent which assists the surfactant to remove soils such as those commonly encountered in the household. The organic cleaning solvent also can participate in the building of viscosity, if needed, and in increasing the stability of the composition. The compositions containing an alkyl sulfates surfactant also have lower sudsing characteristics when the solvent is present. Thus, the suds profile can be controlled in large part by simply controlling the level of hydrophobic organic cleaning solvent in the formulation. Additionally, it is found that organic solvents facilitate the rinsing of compositions comprising alkyl sulfates. It is believed that the rinse benefits follow from lower suds level and that organic solvents suppress suds in an analogous manner to silicone oils, by occupying sites at the air-water interface while not being surface active. Thus, more hydrophobic solvents such as dipropylene glycol butyl ether are stronger suds suppressors than less hydrophobic solvents such as propylene glycol butyl ether.

Thus, the concentrate of this invention may include such solvents that typically have a terminal C₃-C₆ hydrocarbon attached to from one to three ethylene glycol or propylene glycol moieties to provide the appropriate degree of hydrophobicity and, preferably, surface activity. Examples of commercially available hydrophobic cleaning solvents based on ethylene glycol chemistry include mono-ethylene glycol n-hexyl ether (Hexyl Cellosolve® available from Union Carbide). Examples of commercially available hydrophobic cleaning solvents based on propylene glycol chemistry include the di-, and tri-propylene glycol derivatives of propyl and butyl alcohol, which are available from Arco Chemical, 3801 West Chester Pike, Newtown Square, Pa. 19073) and Dow Chemical (1691 N. Swede Road, Midland, Mich.) under the trade names Arcosolv® and Dowanol®.

In the context of the present invention, preferred solvents are selected from the group consisting of mono-propylene glycol mono-propyl ether, mono-propylene glycol mono-butyl ether di-propylene glycol mono-propyl ether, di-propylene glycol mono-butyl ether; tri-propylene glycol mono-butyl ether; ethylene glycol mono-butyl ether; di-ethylene glycol mono-butyl ether, ethylene glycol mono-hexyl ether and di-ethylene glycol mono-hexyl ether, and mixtures thereof. “Butyl” includes both normal butyl, isobutyl and tertiary butyl groups. Di-propylene glycol mono-butyl ether is most preferred cleaning solvent and is available under the trade names Arcosolv DPnB® and Dowanol DPnB®. Di-propylene glycol mono-t-butyl ether is commercially available from Arco Chemical under the tradename Arcosolv®.

Other solvents which can be used include C₁-C₆ alkanols. It is especially preferred to add isopropanol to the ether solvents when used.

The amount of organic cleaning solvent can vary depending on the amount of other ingredients present in the composition. The hydrophobic cleaning solvent is normally helpful in providing good cleaning. In general, 0 to 45 wt. % of the concentrate will comprise the hydropholic ether solvents. If used, preferably 5 to 35 wt. % of such solvents are used. In addition, 0 to 65 wt. % alkanol, such as isopropanol can be used along with the hydrophobic ether solvents, preferably, 5 to 60 wt. %.

Optional ingredients which can be included in the concentrates of the invention in conventional levels for use include solvents, hydrotropes, processing aids, corrosion inhibitors, dyes, fillers, optical brighteners, germicides, pH adjusting agents (monoethanolamine, sodium carbonate, sodium hydroxide, hydrochloric acid, phosphoric acid, et cetera), bleaches, bleach activators, perfumes and the like.

The following examples represent three different concentrates and the diluted cleaning formulations within the scope of the invention.

### EXAMPLE 1

Multi-Purpose Cleaner

| | | | | |
|---|---|---|---|---|
| Trade Name | Chemical Name | Purpose | % Active | % Weight |

Concentrate Formulation:

| | | | | |
|---|---|---|---|---|
| DI Water | Deionized Water | | 100% | 29.34 |
| AMP-95 | 2-amino-2-methyl propanol | Solvent | | 10 |
| Versene Acid | Ethylenediaminetetraacetic acid | Chelating Agent | 100% | 1.5 |
| (EDTA) | | | | |
| Texapon 842 | Sodium Octyl Sulfate | solubilizer/hydrotropic | | 10 |
| | | agent | | |
| Dehypound | N/A | Nonionic surfactant blend | 100% | 7 |
| Advance | | | | |
| Dowanol PnB | Propylene Glycol Monobutyl Ether | Solvent | | 15 |
| Dowanol DPM | Dipropylene Glycol Monomethyl | Solvent | >99.0% | 15 |
| | Ether | | | |
| IPA | Isopropanol | Solvent | >=99.5 | 10 |
| | Fragrance | Fragrance | | 1.89 |
| Dye Green | Dye Green | Polymeric Colorant | 100% | 0.27 |
| Total | | | | 100 |

Diluted Formulation:

| | | | | |
|---|---|---|---|---|
| DI Water | Deionized Water | | 100% | 97.37 |
| AMP-95 | 2-amino-2methyl propanol | Solvent | | 0.370 |
| Versene Acid | Ethylenediaminetetraacetic acid | Chelating Agent | 100% | 0.060 |
| (EDTA) | | | | |
| Texapon 842 | Sodium Octyl Sulfate | solubilizer/hydrotropic | | 0.370 |
| | | agent | | |
| Dehypound | N/A | Nonionic surfactant blend | 100% | 0.260 |
| Advance | | | | |
| Dowanol PnB | Propylene Glycol Monobutyl Ether | Solvent | | 0.560 |
| Dowanol DPM | Dipropylene Glycol Monomethyl | Solvent | >99.0% | 0.560 |
| | Ether | | | |
| IPA | Isopropanol | Solvent | >=99.5 | 0.370 |
| | Fragrance | Fragrance | | 0.070 |
| Dye Green | Dye Green | Polymeric Colorant | 100% | 0.010 |
| Total | | | | 100.000 |

### EXAMPLE 2

Heavy Duty Degreaser

| | | | | |
|---|---|---|---|---|
| Trade Name | Chemical Name | Purpose | % Active | % Weight |

Concentrate Formulation:

| | | | | |
|---|---|---|---|---|
| DI Water | Deionized Water | | 100% | 21.19 |
| Dehypound Advance | N/A | Nonionic surfactant blend | 100% | 50 |
| AMP-95 | 2-amino-2-methyl propanol | Solvent | | 10 |
| Potassium Hydroxide | N/A | Builder | 45% | 7 |
| Versene Acid (EDTA) | Ethylenediaminetetraacetic acid | Chelating Agent | 100% | 4 |
| Texapon 842 | Sodium Octyl Sulfate | solubilizer/hydrotropic | | 5 |
| | | agent | | |
| Fragrance | | Fragrance | | 2.7 |
| Dye Milliken Bright Yellow | Yellow | Polymeric Colorant | 100% | 0.11 |
| Total | | | | 100 |

Diluted Formulation:

| | | | | |
|---|---|---|---|---|
| DI Water | N/A | | | 97.08111111 |
| Dehypound Advance | N/A | Nonionic surfactant blend | 100% | 1.852 |
| AMP-95 | N/A | Solvent | | 0.370 |
| Potassium Hydroxide | N/A | Builder | 45% | 0.259 |
| Versene Acid (EDTA) | Ethylenediaminetetraacetic acid | Chelating Agent | 100% | 0.148 |
| Texapon 842 | Sodium Octyl Sulfate | solubilizer/hydrotropic | | 0.185 |
| | | agent | | |
| Fragrance | | Fragrance | | 0.100 |
| Dye Milliken Bright Yellow | Yellow | Polymeric Colorant | 100% | 0.004 |
| Total | | | | 100.000 |

### EXAMPLE 3

Glass Cleaner

| | | | | |
|---|---|---|---|---|
| Trade Name | Chemical Name | Purpose | % Active | % Weight |

Concentrate Formulation:

| | | | | |
|---|---|---|---|---|
| DI Water | Deionized Water | | 100% | 16 |
| Versene Acid-100% | Ethylenediaminetetraacetic Acid | Chelating Agent | 100% | 2 |
| AMP-95 | 2-amino-2-methyl propanol | Solvent | | 10 |
| Stepanol-WA-Extra | Sodium Lauryl Sulfate | Surfactant | | 2 |
| Dowanol DPM | Dipropylene Glycol Monomethyl Ether | Solvent | >99.0% | 5 |
| Dowanol PnB | Propylene Glycol Monobutyl Ether | Solvent | | 5 |
| IPA | Isopropanol | Solvent | >=99.5 | 58.515 |
| Fragrance | | Fragrance | | 1.35 |
| Dye Milliken Blue | Blue | Polymeric Colorant | 32% | 0.135 |
| Total | | | | 100 |

Diluted Formulation:

| | | | | |
|---|---|---|---|---|
| DI Water | Deionized Water | | 100% | 96.8889 |
| Versene Acid-100% | Ethylenediaminetetraacetic acid | Chelating Agent | 100% | 0.0741 |
| AMP-95 | 2-amino-2-methyl propanol | Solvent | | 0.3704 |
| Stepanol-WA-Extra | Sodium Lauryl Sulfate | Surfactant | | 0.0741 |
| Dowanol DPM | Dipropylene Glycol Monomethyl Ether | Solvent | >99.0% | 0.1852 |
| Dowanol PnB | Propylene Glycol Monobutyl Ether | Solvent | | 0.1852 |
| IPA | Isopropanol | Solvent | >=99.5 | 2.1672 |
| Fragrance | | Fragrance | | 0.05 |
| Dye Milliken Blue | Blue | Polymeric Colorant | 32% | 0.005 |
| Total | | | | 100 |

1. An aqueous cleaning concentrate diluteable with water to prepare an aqueous cleaning solution comprises: a chelating agent, and aminoalkanol solvent, at least one surfactant and water, said water being present in amounts of 10-30 wt. % based on the weight of the concentrate.

2. The aqueous concentrate of claim 1 wherein water is present in amounts of from greater than 10 to less than 30 wt. % of the concentrate.

3. The aqueous concentrate of claim 1 wherein said chelating agent is EDTA.

4. The aqueous concentrate of claim 1 wherein said aminoalkanol solvent is 2-amino, 2-methyl propanol.

5. The aqueous concentrate of claim 1 including an anionic surfactant comprising an alkyl sulfate.

6. The aqueous concentrate of claim 1 comprising a nonionic surfactant comprising a mixture of an alkyl polyglycoside and an alkoxylated alcohol.

7. The aqueous concentrate of claim 1 further including an organic solvent selected from alkyl alcohols, glycol ethers, and mixtures thereof.

8. The aqueous concentrate of claim 7 comprising a mixture of dipropylene glycol monobutyl ether, propylene glycol monomethyl ether, and isopropanol.

9. The aqueous concentrate of claim 8 comprising 5-35 wt. % of said glycol ethers and 5-60 wt. % of said isopropanol, based on the weight of said concentrate.

10. The aqueous concentrate of claim 1 wherein said chelating agent is present in amounts of from 1-5 wt. % of said concentrate and said aminoalkanol solvent is present in amounts of from 5-15 wt. % of said concentrate.

11. The aqueous concentrate of claim 1 further including an alkali metal hydroxide.

12. The aqueous concentrate of claim 11 which is devoid of alcohol and glycol ether solvents.

13. The aqueous concentrate of claim 1 further including sodium octyl sulfate.

14. The aqueous concentrate of claim 1 in the form of a 15-200 ml volume solution.

15. A method of forming an aqueous cleaning solution useful for cleaning hard surfaces comprises, forming an aqueous concentrate comprising water, a chelating agent, aminoalkanol solvent, and at least one surfactant, and wherein the water content of said aqueous concentrate is from 10-30 wt. %, mixing said aqueous concentrate with additional water such that said aqueous concentrate comprises 2-6% by weight of the total cleaning composition.

16. The method of claim 15 wherein said aqueous concentrate comprises greater than 10 to less than 30 wt. % water.

17. The method of claim 15 wherein said aqueous concentrate further contains organic solvent selected from glycol ethers, alcohols, and mixtures thereof.

18. The method of claim 15 wherein said chelating agent is EDTA and said aminoalkanol solvent is 2-amino, 2-methylproponal.

19. The method of claim 15 wherein said at least one surfactant comprises an anionic surfactant of an alkyl sulfate, a nonionic surfactant comprising a mixture of an alkyl polyglycoside and alkoxylated alcohols, or a mixture of said anionic or nonionic surfactants.

20. The method of claim 15 comprising adding said aqueous cleaning concentrate and additional water to a container to form a diluted concentrate and cleaning solution, said container being provided with a trigger type sprayer to apply the cleaning solution to a surface.
